(19) United States
(12) Patent Application Publication
(10) Pub. No.: US 2015/0170043 A1
(43) Pub. Date: Jun. 18, 2015

(54) Decentralized Expert System for Network-Based Crowdfunding

(71) Applicant: Crowd IP GmbH, Pullach (DE)

(72) Inventors: Yorck Raul Hernandez, Pullach (DE); Gunnar Eisenberg, Brieselang (DE)

(73) Assignee: Crowd IP GmbH

(21) Appl. No.: 14/568,505

(22) Filed: Dec. 12, 2014

Related U.S. Application Data
(60) Provisional application No. 61/916,251, filed on Dec. 15, 2013.

(30) Foreign Application Priority Data
Dec. 11, 2014 (DE) 10 2014 118 401.7

(51) Int. Cl. G06N 5/04

(52) U.S. Cl. CPC G06N 5/043

(57) ABSTRACT

The invention relates to an expert system (10) having at least one central processing unit (K*) and having first and second processing units (K″, R) that can be determined by software download to client computers (C) that are connected via a network (WWW), wherein the expert system (10) is set up, based on a modeled transfer function for input data (E), to generate associated output data (A) and output them to connected client computers (C), wherein the expert system (10) is set up to record direct and/or indirect interactions of a user (N) of a client computer (C) as input data (E), wherein the expert system (10) has at least one server computer (S) with the central processing unit (K*), wherein the server computer (S) is set up to connect via the network (WWW) to a client computer (C) after a software download of the distributable first and second processing units (K″, R) onto the client computer (C), the latter occurring by means of a data-communicating connection, wherein the distributable second processing units (R) are configured to connect as peers to client computers (C) that are connected to the server computer (S) via the network (WWW) with a data-communicating connection, and—based on first input data derived from the respective user of the client computer (C) and second input data transmitted by other client computers (C)—to transmit a change in the output data (A) derived by the first processing unit (K″) to the server computer (S), and to transmit second input data derived by the second processing unit (R) to all of the other connected client computers (C), wherein the server computer (S) is set up to receive the derived change in the output data (A) from all of the connected client computers (C) and to use them as input data for the central processing unit (K*) in order to derive current values of the output data (A) and to transmit them to all of the connected client computers (C) again.

### CROSS-REFERENCE TO RELATED APPLICATIONS

This patent application claims the benefit of U.S. Provisional Patent Application Ser. No. 61/916,251, filed Dec. 15, 2013, and German Patent Application Number 10 2014 118 401.7, filed Dec. 11, 2014, which applications are incorporated in their entirety here by this reference.

### TECHNICAL FIELD

The invention generally relates to the implementation of a network-based crowd service. In particular, the invention relates to the structure of an expert system, which is suitable for a decentralized implementation of a crowdfunding platform as a crowd service on the Internet as a network.

### BACKGROUND

Crowd services can be roughly broken down into crowdsourcing and crowdfunding. Crowdsourcing describes methods in which a large group of users as a swarm performs a task. Examples of this are all of the co-written articles in the encyclopedia wikipedia.org. Crowdfunding describes the group financing of an investment by a group of users. Examples of this include, for example, the product-based (reward-based) crowdfunding of the sales platforms kickstarter.com or indiegogo.com—in which the user group as a rule pre-finances an industrial production of a product—or an (equity-based) crowdfunding on the platforms wefunder.com or seedmatch.de. Equity-based crowdfunding is also referred to as crowd investing for better differentiation.

With regard to the topic of crowdfunding, we hereby make general reference to: US 2014/0316823 A1, US 2014/0310200 A1, US 2014/0279682 A1, US 2014/0164291 A1, US 2014/0067644 A1, US 2014/0052668 A1, US 2014/0040157 A1, US 2014/0025473 A1, and WO 2014/115927 A1.

A core idea behind crowd services is that the users as a swarm have a natural swarm intelligence, a fact known from biology and from research into artificial intelligence. The term “swarm intelligence” means that the decision by the crowd is better than the average decision of each individual and that it is possible as an individual user to join the crowd with a low risk. The technical problem in the implementation, however, is that the ways in which individual users behave cannot be comprehensively captured and analyzed because this would mean the transport and central evaluation of huge, exponentially rising quantities of data. Consequently, the actual strength of swarm intelligence remains largely untapped in prior-art crowd services since the user data is acquired in only a very rudimentary fashion. In other words, a network-based crowdfunding platform on a server that is accessible via the Internet and that takes into account the current interactions of each user in real time cannot be technically implemented at this time. The data quantities that accrue and are in constant need of processing and generation—in real time if possible—are too large to be efficiently analyzed by currently available computer farms, particularly since computer farms that are currently available for reasonable costs do not have a high enough speed or computing power. Also, the required bandwidth for the data exchange that is continuously required in real time between the platform and the users does not exist on the Internet, i.e. the available bandwidths are too low to be able to acquire all of the data in real time.

### SUMMARY

One object of the present invention is to propose a technical implementation for a network-based computing system for a crowdfunding platform, by means of which or in which the above-mentioned technical problems are avoided at least to the extent that when the crowdfunding platform is properly operating in a starting phase, there is no need to fear a breakdown when there is an increase in the number of users and/or an increase in the number of investments.

The object is attained with the features of the independent claims. Other exemplary embodiments and advantageous modifications ensue from the dependent claims, the description, and the drawings.

A core concept of the invention lies in the special architecture of the expert system proposed here, in which the data processing of the expert system is distributed between the individual clients of the users of the system and at least one central server of the system in such a way that virtually every user with his client computer adds the necessary resources to the system so that the system as a whole has enough power to meet the technical demands. The system introduced here thus has a scalability of the accrued computing load and the accrued data transfer in that each client computer brings its own computing power in order to process the data of the user who is using the client computer.

### BRIEF DESCRIPTION OF DRAWINGS

FIG. 1 shows a block circuit diagram of an expert system with data streams between a plurality of terminal computers and a server computer.

FIG. 2 shows a block circuit diagram of an expert system equipped with symbolic and statistical AI-based processor units.

FIG. 3A shows a block circuit diagram to illustrate the linearization of the feedback expert system from FIG. 1.

FIG. 3B shows another depiction of the block circuit diagram from FIG. 3A to better illustrate the linearization of the feedback expert system from FIG. 1.

FIG. 4A shows a block circuit diagram to illustrate the distributed data processing of the expert system, which takes place in a client computer.

FIG. 4B shows a block circuit diagram to illustrate the distributed data processing of the expert system, which takes place in a server computer.

### DETAILED DESCRIPTION OF THE INVENTION

Other advantages, features, and details of the invention ensue from the following description in which an exemplary embodiment of the invention is described in detail with reference to the drawings. The features mentioned in the claims and in the description can each be essential to the invention in and of themselves or can be essential to the invention in any combination with one another. In the same way, the features mentioned above and explained in greater detail here can each be used by themselves or be united in any combination with one another. Some parts or components that are functionally similar or identical have been provided with the same reference numerals. The terms “left,” “right,” “top,” and “bottom” used in the description of the exemplary embodiment refer to the drawings in an orientation in which description of the figures can be normally read and the reference numerals can be normally read. The embodiment shown and described is understood to be non-exclusive. The purpose of the detailed description is to provide information to the person skilled in the art; for this reason, known switches, structures, and methods are not shown or explained in detail in the description in order not to complicate comprehension.

With the expert system proposed below, it should be possible, for example, to construct a network-based service with any number of users. An essential aspect is that the complexity of the expert system, particularly its resource requirements from the point of view of the operator or provider, should be as independent as possible from the number of users of the expert system and the quantity of data to be processed.

In order to better illustrate the following description of the special technical features and requirements of the expert system and its implementation with regard to configuration and structure, the first description given here is of a practical use of the expert system, namely the specific implementation of a likewise novel network-based crowdfunding platform.

The fact that the expert system that constitutes the crowdfunding platform must, for a large number n of users N for each of a number k of investments offered by means of an associated campaign K, evaluate in real time a number e of input data E(k, e), in order to derive from this a number a of output data A(k, a) for each campaign K(k). Naturally, even more input values can be added or if necessary, certain of the input values mentioned here can be omitted; they can if necessary be replaced by others such as various general factors from the Internet (WWW), e.g. results of bot searches and crawlers, keywords, and listings in search engines.

The underlying technology is hidden from a user N of the expert system; he sees and is essentially only interested in the respectively current results A(k, a) for a campaign K(k) that he is currently considering, i.e. the associated investment.

The expert system is set up so that it first shows a user the most popular investments in a campaign overview (for example on an Internet site). The popularity as a measure for a current interest of users in a particular investment is described by a corresponding ranking. In other words, the higher the ranking of an investment currently is, the more prominently this investment is displayed to a user N who looks at the overview.

The expert system is set up so that in an investment phase, the price of a share (market price) of an investment starts at a fixed value. The expert system is also set up so that the market price rises as a function of the internal ranking of the investment, i.e. the market price is dynamic. To that end, the expert system continuously determines the market price in real time. The expert system is also set up so that the market price for the most popular investments rises more quickly and/or more sharply than for other investments. In other words, for an investment with a high ranking, i.e. high popularity, the market price rises more quickly and/or by greater increments than for other investments with a low ranking. Both measures feel very intuitive for a user N.

The expert system is also set up so that the market price of an investment never decreases. This increases the incentive for the individual users N to invest as early as possible in an investment phase.

The expert system can also be set up so that each user N is guaranteed the market price that was most recently displayed to him for the duration of an investment procedure.

The expert system is also set up so that a user N of the expert system can browse through the various investments currently offered. To that end, the individual investments are presented in their associated campaigns K(k), for example by means of text and/or images and/or videos, where the arrangement of the investments takes place dynamically and based on their respective ranking. The individual user N can have investments that are offered on the platform displayed so that they are filtered or sorted by particular categories.

On the whole, the expert system imitates/models the organizational behavior of a person with regard to the presentation of investments and the price development on a marketplace with many bidders.

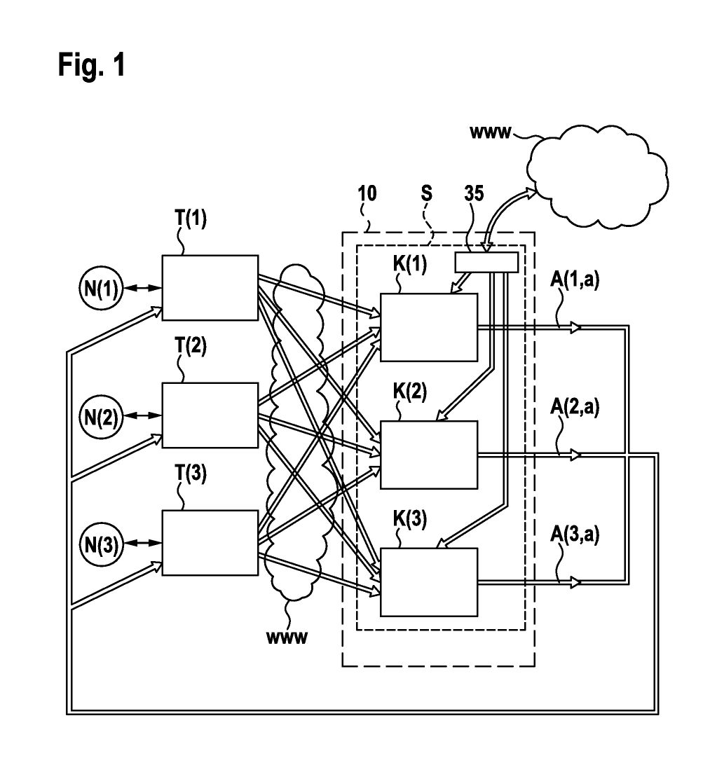

FIG. 1 shows the expert system 10 as a platform for the crowdfunding that is described above by way of example. The expert system 10 is first depicted as a host/terminal system. Each user N(n) of the system is associated with a terminal computer T(n). The corresponding software modules for data processing of the expert system 10 are located entirely on a server computer S functioning as a host at the provider of the crowdfunding platform.

The terminal computers T(n) essentially function only as input/output (I/O) interfaces of the expert system 10 and do not themselves have any “intelligence” as far as the expert system 10 is concerned. For example, a terminal computer T(n) is a normal PC. on which for example an Internet browser is running that can be used to access the Internet site of the provider of the expert system 10. The browser window is then effectively the I/O interface between a user N and the expert system 10. The individual terminal computers T(n) are connected via the Internet WWW to the server computer S functioning as the host. In addition, the server computer S is connected via a unit 35 to additional data sources on the Internet WWW. The unit 35 can, for example, be set up to include additional input data in the form of the results of bot searches and crawlers, keywords, and listings in search engines, etc.

In the example, merely for simplification purposes, only three (n=3) users N(1), N(2), N(3) and three associated terminal computers T(1), T(2), T(3) are shown. In practice, the number n of users N(n) and terminal computers T(n) will be significantly higher, e.g. n>50,000. The users N(n) are represented as circles in FIG. 1.

For each investment, a campaign K(k) is created in the expert system 10 on the server computer S functioning as the host. In the example shown, three campaigns K(k) are displayed, i.e. in the example shown, there are only three (k=3) investments; in practice, there can be any number of them, e.g. k>100. As input data, the expert system 10 must continuously acquire and evaluate a number e of input values E(k, e) in real time if possible and for each campaign, must output a number a of particular output values A(k, a). In so doing, each campaign K(k) is implemented by a correspondingly programmed processing unit K(k), which is set up to use the respective input values E(k, e) to generate the associated output values A(k, a); i.e. for the sake of a simplified depiction here, the processing units K(k) are depicted as the associated campaigns K(k).

For the technical implementation of the expert system 10, it is problematic that with an increasing number n of users N(n) and an increasing number k of campaigns/processing units K(k), very large quantities of data are acquired at all times as input signals E(k, e). The processing units K(k) of the expert system 10 must analyze and evaluate the input data in real time in order, for example based on the respective input data E(k, e) of a campaign K(k), to be able to generate as output signals the values for the current market price A(k, 1) and the current ranking A(k, 2) of the investment of the campaign K(k); in other words, each processing unit K(k) has two output values (a=2). As is already clear from the ranking, the individual campaigns K(k) influence one another. In the expert system 1 shown in FIG. 1, it is particularly problematic that it is a nonlinear system with feedback.

For a number of reasons, the above-mentioned expert system 10 that is schematically depicted in FIG. 1 cannot easily be implemented directly as a terminal/server system:

The data quantities E(k, e) and A(k, a) that occur and that must be continuously processed and generated are too large to be efficiently analyzed on currently available server computers S. Computer farms that are currently available for reasonable costs have too low a speed or computing power.

The required bandwidth for a data exchange that is continuously required in real time between the server computer S and the terminal computers T(n) of users N(n) does not exist in a network like the Internet (WWW). In other words, the available bandwidths are too low to be able to continuously acquire all of the data in real time.

Classical analysis methods for processing the input data E(k, e) into the required output data A(k, a), for example in the form of fixed transfer functions or matrices, fail due to the data quantity and implementation speed; lookup tables also fail due to the theoretically required size.

All of the data cannot be sorted or indexed in real time since they are overtaken too quickly by new data.

Even without the feedback(s), the high-level internal networking of the elements of the expert system means that gigantic quantities of data must be processed, which become exponentially larger due to the feedback.

If one qualitatively considers the required computing operations O and the data quantity D generated as a function of the connected n users N and k campaigns K, then a direct implementation of the expert system 10 theoretically involves the following interdependences:

O(E*n*k+A*k̂2) and D(E*n*k+A*k̂2).

This is explained by the fact that in each of the k campaigns K, the n input data vectors E of the n users N and the k output data vectors A of the feedback must be acquired (D) and processed (O). With a total of k campaigns K, this yields (E*n+A*k)*k as a basis term. In this connection, it must be noted that each input data vector E and each output data vector A is in turn itself composed of a potentially large quantity of individual values and that all operations and data must flow together in the server computer S as a hardware unit.

The structure for the expert system 10 envisaged here should if possible reduce the data quantity D and computing operations O in the server computer S to O(A*k̂2) and D(A*k̂2).

The specific technical measures explained below are proposed in order to be able to solve these technical problems during implementation to the extent that the expert system 10 is technically implementable.

A first aspect of the solution proposed here lies in the fact that during the processing of the data, artificial intelligence methods (AI methods) are used instead of using classical methods such as fixed transfer functions/-matrices or lookup tables.

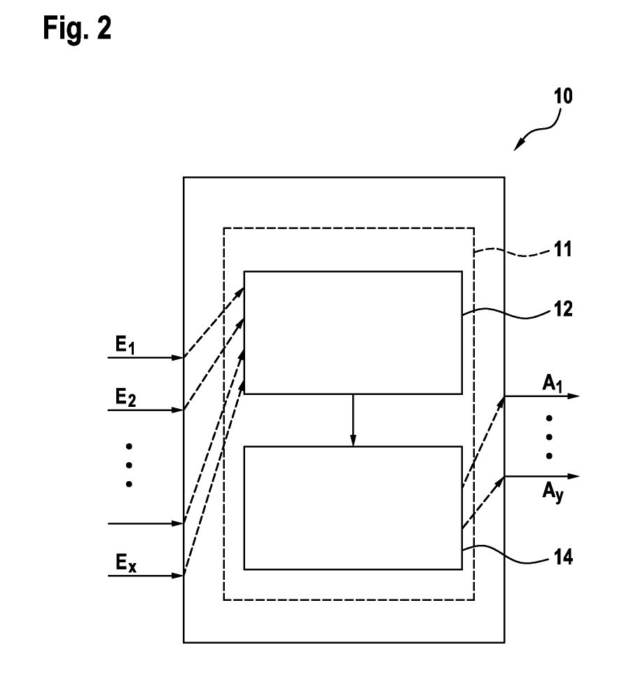

To this end, FIG. 2 shows a very simplified block circuit diagram of the expert system 10 from FIG. 1, which is programmed on the underlying server computer S functioning as a processing unit K. The expert system includes an AI processing unit 12 based on statistical artificial intelligence (AI) and an AI processing unit 14 based on symbolic AI. The respective AI processing units 12, 14 are set up to generate, based on a large amount of input data E, a small amount of output data A for each campaign K in real time. These continuously updated output data A assist a user N of the expert system 10 in making his investment decisions.

The statistical AI of the AI processing units 12 is trained in advance with simulated input data or during ongoing operation using particular models, e.g. Gaussian mixture models (GMMs) or hidden Markov models (HMMs). During the training, the parameters of the models are trained toward a ground truth, i.e. adapted so that when input data are fed in from the model, the desired output data are generated. When the model has achieved a desired precision, then the training is considered to have been successfully completed. The training can be carried out with simulated data and/or can be readjusted during ongoing operation of the expert system 10 with really detected data.

The subsequent symbolic AI of the AI processing unit 14 makes final decisions according to a fixed, programmed set of rules based on the output values of the statistical AI and produces the output values A of the respective campaign K. The set of rules and the decision thresholds of the statistical AI are fixed in advance and can likewise be readjusted during ongoing operation of the expert system 10.

In the example of the crowdfunding platform, the e input data E(k, 1), . . . , E(k, e) to be continuously processed by the expert system 10 for each of the k campaigns K(k) can be:
A current investment sum E(k, 1) of the campaign K(k),
The request frequency E(k, 2) of the information about the investment of the campaign K(k) by users,
The number and length of comments E(k, 3) of users about the campaign K(k) e.g. in Internet forums,
The number of forwards E(k, 4),
The number of arrivals/departures E(k, 5) from other relevant (Internet web) sites,
The length of time E(k, 6) users look at the data about the investment of the campaign K(k),
The number of linkings (Internet links) to the campaign K(k) on social media sites E(k, 7).

In other words, the number e of the items of input data is 7 (e=7).

These input data are analyzed and evaluated in real time by the expert system 10 in order to issue the following output signals for each campaign K(n):
The values for the current market price A(k, 1) of a share of the investment and
The current ranking A(k, 2) of the investment of the campaign K(k).

In other words, the number a of the items of output data is 2 (a=2).

A second aspect of the solution proposed here is the removal of the system-internal feedback between the individual campaigns K. To achieve this, the expert system 10 has been linearized in that in each campaign K(i), the data that are relevant for the respective other campaigns K are evaluated and distributed separately.

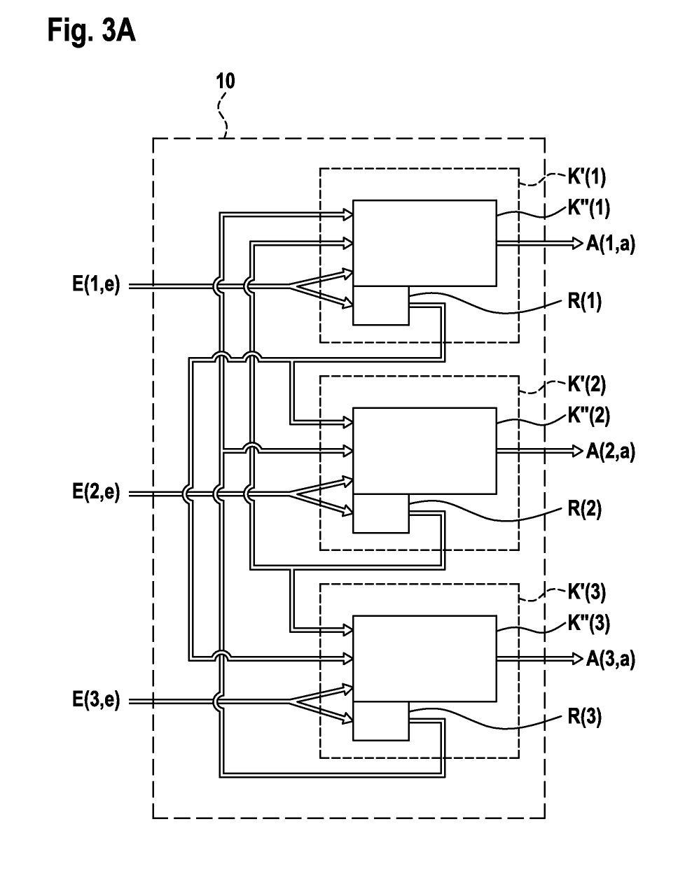

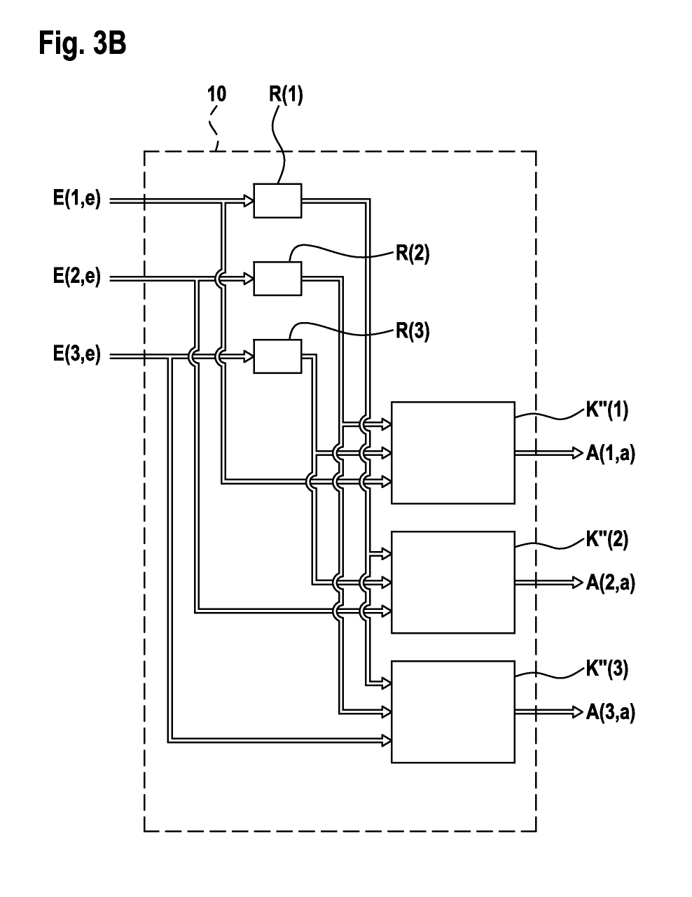

As shown in FIG. 3A, the input data E(k, e) of each processing unit K′(k) implementing a campaign are the same as the data that in FIG. 1 and FIG. 2 go into each of the processing units K(k) implementing the associated campaigns. By contrast with FIG. 1, now for each campaign K′(k), a processing of the data takes place in parallel in a first processing unit K″(k) and a second processing unit R(k). These first processing units K″(k) and second processing units R(k), respectively, are themselves once again composed of AI processing units according to the diagram in FIG. 2 and as a result, issue so-called facts as core data and so-called volatile data, respectively.

FIG. 3B corresponds in content to FIG. 3A and shows the linearization in that the processing units K′(k), which were introduced only for the sake of better comprehension, have been disconnected and broken down into two functional blocks K″(k) and R(k) with no feedback.

The output data of the respective second processing units R(k) in this case are understood to be volatile data. Volatile data provide information that can be gleaned from the behavior of a user with regard to a particular campaign, but can also be evaluated in relation to all of the other campaigns in addition to the particular campaign. These data are therefore referred to as volatile because their evaluation makes the overall system better and more precise, but they do not always necessarily have to be evaluated by all campaigns or made available. The overall system features a high error tolerance in relation to the failure or late arrival of data from the second processing units R(k).

The counterpart to the volatile data are the facts as core data that are generated in the first processing units K″(k). These are absolutely necessary for the functioning of the expert system 10 and are absolutely required by the server computer S for the subsequent evaluation of the various campaigns by means of AI processing units on the server computer S.

The first and second processing units K″(k) and R(k) can be visualized as twins that evaluate the same information, but in different ways. The first processing unit K″(k) evaluates the input data E(k, e) for the associated campaign K(k) and the second processing unit R(k) evaluates the input data for the rest of the campaigns in addition to the associated campaign. The results from all of the other second processing units R(k) flow into the evaluation in the first processing units K″(k). The first and second processing units K″(k) and R(k) in this case act in opposition from a qualitative standpoint, but are not permanently connected. For the sake of illustration, let us consider the following contrived extreme examples:

### Example 1

All of the users N pay attention only to campaign K(1) and only view this campaign K(1), click the prepared information about it, link to the campaign K(1) on social media websites, discuss the campaign K(1) on Internet forums, etc. In this case, the first processing unit K″(1) reports positive values and the second processing unit R(1) reports that the other campaigns K(2), K(3) are attracting little attention, i.e. have negative output values.

### Example 2

All of the users N pay the same amount of attention to all of the campaigns K(1), K(2), K(3), but 10% of users N also purchase shares of the investment in campaign K(1). The first processing unit K″(1) then once again reports positive values due to the occurrence of a certain amount of attention and purchases. The second processing unit R(1), however, does not necessarily evaluate the purchases in campaign K(1) as a negative development for the other campaigns K(2), K(3) and reports neutral values.

### Example 3

All of the users N pay attention only to campaign K(1) and click on the prepared information about it, link to the campaign K(1) on social media websites, discuss only this campaign K(1) on Internet forums, etc., but purchase in campaign K(2) without long turnaround times. In this case, the first processing unit K″(1) reports positive values and the second processing unit R(1) does, too, because at least one other campaign, namely campaign K(2), must also be evaluated as strong due to the purchases.

A third aspect of the solution proposed here relates to the structure of the expert system 10 as a decentralized system. In this case, the proposal is made to implement the expert system 10 by means of a mixture of a peer-to-peer (P2P) structure and a server/client structure. In other words, the expert system is expanded from the server computer S to all of the involved terminal computers T(n) in FIG. 1, which are then actual client computers C(n). In other words, the client computers C(n) are no longer—to the extent that this concerns the functions of the expert system 10—pure terminals T(n) that effectively function only as an I/O interface with the expert system 10 for the respective user N. Instead, the client computers C(n) are now true data processing components of the expert system 10. To that end, in addition to the AI processing units 12, 14 on the server computer S, AI preprocessing units 29 in each client computer C(n) are set up to preprocess the data generated there. This can be implemented, for example, in the form of corresponding Java applets on each client computer C(n). In AI processing units 29, the input vectors E can be many times greater (e.g. by a factor of 10 to 100) than the output vectors A. This means that the larger portion of the data quantity and computing operations no longer occurs on the server computer S, but in a decentralized fashion on the client computers C(n). As a result, the computing load can be uniformly distributed locally in a scalable fashion per client computer C(n).

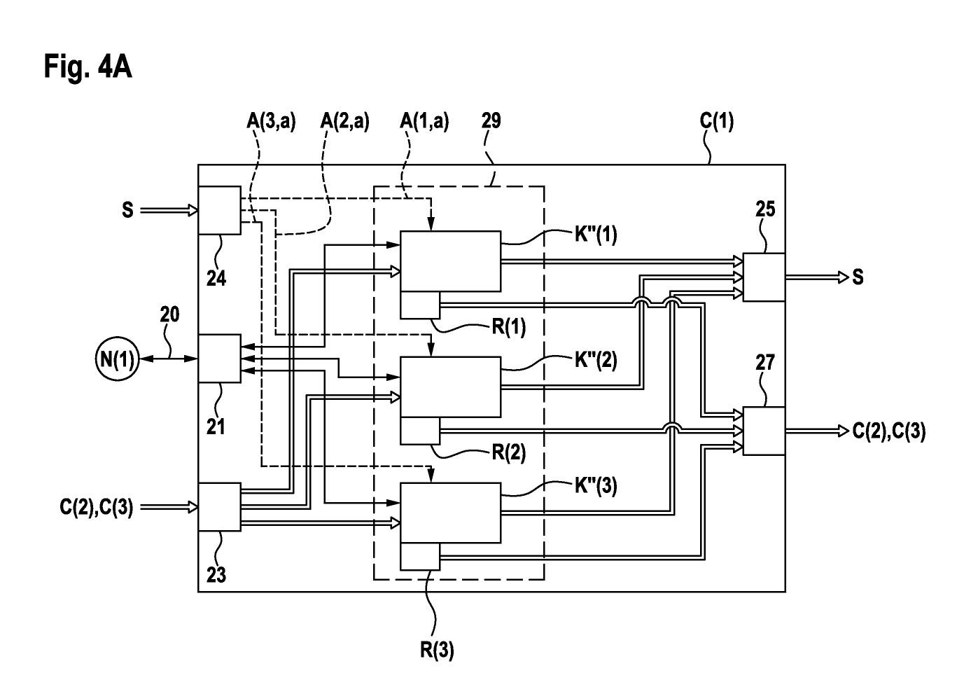

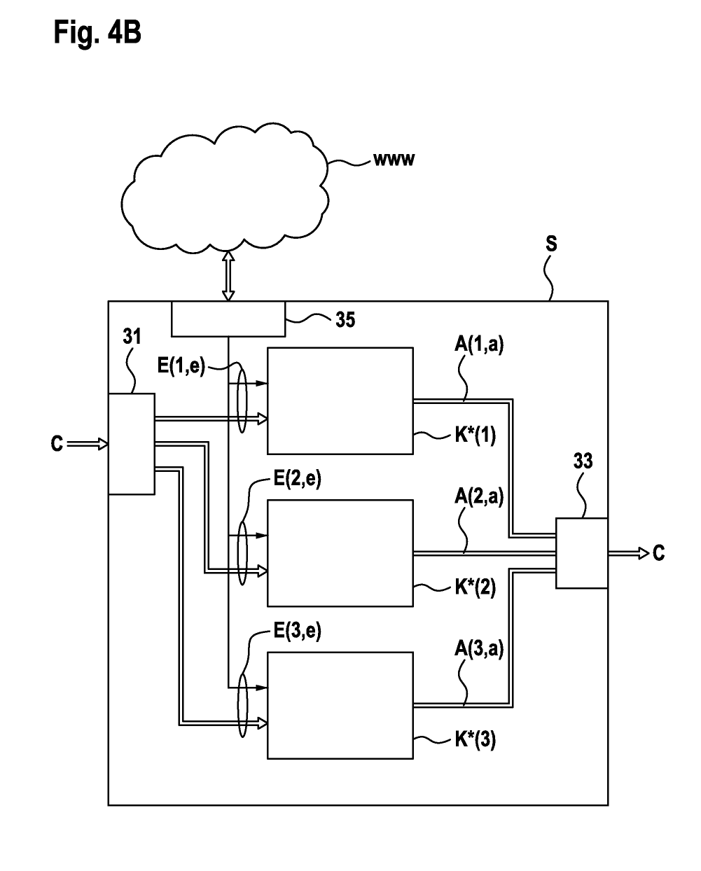

In FIG. 4A, this is shown in the example of the client computer C(1), which replaces the terminal computer T(1) from FIG. 2. In the client computer C(1), a preprocessing of a majority of the pure user data of the user N(1) takes place in a correspondingly programmed computer program 29, e.g. a Java applet. On the one hand, the client computer C(1) is connected by means of a suitable network connection via the Internet WWW to the server computer S of the expert system 10. This client/server relationship between the client computer C(1) and the server computer S is the client/server structure component of the expert system 10.

But the other client computers C(2) and C(3) connected to the expert system 10 are also connected to the client computer C(1) as peers. This P2P relationship between the client computers C(1) through C(3) is the P2P structure component of the expert system 10.

In the computer program 29, corresponding first processing units K″ for each campaign K(1), K(2), K(3) are programmed, which are set up for the relevant preprocessing of the core data of the respective campaign (also see FIGS. 3A and 3B and the associated description). Each first processing unit K″ once again contains the AI processing units explained in conjunction with FIG. 2.

By means of a first transmitting module 25, the client computer C(1) sends the preprocessed core data for the respective campaign K(1), K(2), K(3) to the server computer S.

By means of a second transmitting module 27, the client computer C(1) transmits the volatile data, which have been preprocessed for its peers in corresponding second processing units R, to the other client computers C(2) and C(3) (also see FIGS. 3A and 3B and the associated description).

By means of a first receiving module 23, the client computer C(1) receives volatile data that are relevant for the individual campaigns K(1), K(2), K(3) from its peers, i.e. campaign data that have been preprocessed by the other client computers C(2) and C(3).

By means of a second receiving module 24, the client computer C(1) receives the current output data A from the server computer S in order to provide the user N(1) with current information. In other words, these current values for A(k, 1) and A(k, 2) are not required in the first and second processing units K″, R. Instead, the user N(1) must be informed of these data. This purpose is likewise served by an MMI interface 21, for example an appropriately embodied browser window, between the computer program 29 and the associated user N(1) of the client computer C(1).

As explained in connection with FIGS. 3A and 3B, the output data of the second processing units R(k) serve as volatile data. In the context of FIG. 4A, the output data of the second processing units R(2) supply information that can be gleaned from the behavior of the user N(1) in relation to the campaign K(2), but can be evaluated in relation to all other campaigns, i.e. in the example, the campaigns K(1) and K(3) in addition to the campaign K(2). These data are therefore referred to as volatile because their evaluation makes the overall expert system 10 better and more precise, but these data do not always necessarily have to be evaluated by all campaigns or made available. The overall expert system 10 features a high error tolerance in relation to the failure or late arrival of data from the second processing units R(k), i.e. from R(1) through R(3) in this instance.

The counterpart to these data are the core data as facts that are generated in the respective first processing units K″(k). These are absolutely necessary for the functioning of the expert system 10 and are absolutely required by the server computer S for the subsequent evaluation of the various campaigns K by means of the AI processing units 12, 14 (FIG. 2) in corresponding central processing units K* in the server computer S.

The calculation of the second processing units R(k) is performed by the client computers C(n) and also relates only to the campaigns with which the user N(n) interacts on his client computer C(n). This makes a significant contribution to the scalability of the expert system 10. The second processing units R(k) are themselves also once again configured with corresponding AI processing units because the second processing units R(k) themselves make the (preliminary) decisions.

The client computers C(n) as peers send one another only volatile data, i.e. the results of the second processing units R(k). It has been determined in simulations that if a data vector is lost in this process, this is not essential to the functionality of the expert system 10. If the entire P2P communication were to theoretically break down, then the expert system 10 would shrink to a classical server-based AI system in which each user generates only input data, which are preprocessed, in particular compressed, by the respective client computer and are then transmitted to the server computer S in linear fashion. The advantage of this is that it retains the distribution of computing load between the client computers C(n) and the server computer S.

In other words, the expert system 10 has (small) AI processing units in three locations according to the diagram in FIG. 2: in each client computer C(n) in the form (i) of first processing units K(k, n) and (ii) second processing units R(k, n), provided that the respective user N(n) interacts with these campaigns (clicks, browses, etc.), and (iii) here once again, for each campaign K(k), a corresponding central processing unit K* runs on the server computer S as the final decision-making unit.

For each campaign K(k), a final decision regarding the current output values A(k, a) is made on the server computer S. The respective central processing unit K*(k) of the server computer S effectively only produces an average of all of the A(k, 1) and A(k, 2), which have been reported by the client computers C(n). This averaging, however, is also once again carried out by means of AI processing units (FIG. 2), preferably simply by means of a statistical AI, i.e. the data run through one or more bell curves. This is likewise carried out according to the invention by means of an AI processing unit according to the diagram in FIG. 2 in which, however, “only” the output data A(k, a) of the client-side K″ are taken into account as input data. Consequently, the above-mentioned large data reduction is also achieved at this point.

The current campaign output data A(k, a) are once again supplied by the server computer S via the Internet WWW to the client computers C(n) (see FIG. 4A). Since this only amounts to a small amount of data, this is not a problem. Consequently, a feedback to the client implicitly takes place, but only with the current output data A(k, a) as information for the user N. These feedback data are not processed further, i.e. they do not contribute to the computing load of the expert system 10.

The above-explained AI-assisted preprocessing of campaign data on the client computers C(n) ensures data protection since sensitive data and the entire behavior record of the user N(n) no longer has to leave the client computer C(n). This also achieves a data reduction since only the result of the processing has to be sent to the server computer S.

The linearization of the original feedback is achieved with the evaluation of the user data in the form of the P2P communication between the client computers C(n). Consequently, the required bandwidth in the communication between the client computers C(n) and the server computer S is significantly reduced because the client computers C(n) as peers have already performed the preprocessing among themselves.

For the communication, the individual client computers C(n) report to the server computer S and establish a direct communication with one another. To that end, the client computers C(n) can, for example, use handshake protocols similar to the ones used by mobile radio devices and radio towers. If an individual client computer fails, then after a time-out, it is removed from the list of the other client computers.

The server computer S only continues to receive the results of the preprocessing on the client computers C(n) and, together with the general data from the network, for example the Internet WWW, determines the output values A(k, a). With the concept presented here, the quantity of data to be processed on the server computer S is manageable.

The expert system 10 can thus efficiently analyze the behavior of the users N as a swarm and in this case, can evaluate the swarm intelligence that is implicitly present in the behavior. The theory behind this evaluation is known from the research field of distributed artificial intelligence; the core of the invention, however, is based on the one hand on acquiring the data quantities as part of a distributed network (WWW) and simultaneously reducing the amount of data so significantly that the theoretically known evaluation can be practically implemented with available hardware. The data reduction introduced by the invention and the reduction in the computing work, along with the possible scalability represent further reduced demands on the hardware and therefore a reduction in costs.

Business methods for which the above-described expert system can be used will be described below by way of example:

1. A method for crowdfunding investments, where for each investment, a current market price and an internal ranking in comparison to all of the investments currently offered are calculated and displayed for users; the investments are displayed in an overview by order of their ranking.

2. The method according to number 1, where the current market price for an investment rises in comparison to the other investments in accordance with its current ranking.

3. The method according to number 1 or 2, where the data to be processed continuously for each investment are one or more of the following data: the current investment sum, the request frequency of the investment, user comments, forwards, arrivals/departures from other relevant sites, turnaround time of users with the data of an investment, density of social medial linking.

4. The method according to number 1, 2, or 3, where users can browse through the data about the investments currently offered, where the individual investments are presented in clearly arranged campaigns with images and videos, where the arrangement of the investments is carried out dynamically and as a function of their current ranking in comparison to the other investments, and where the ranking is continuously determined in real time and the most popular investments are always presented to a user first.

5. The method according to number 1, 2, 3, or 4, where an individual user can also have investments that are currently offered displayed so that they are filtered or sorted by particular categories.

6. The method according to number 1, 2, 3, 4, or 5, where during the investment phase, the market price of an investment starts at a fixed value, which rises dynamically according to the internal ranking of the investment.

7. The method according to number 1, 2, 3, 4, 5, or 6, where a user is guaranteed the market price that was most recently displayed to him for a particular time window in order to process an investment transaction.

8. The method according to number 1, 2, 3, 4, 5, 6, or 7, where the market price of an investment never decreases.

What is claimed is:

1. An expert system having at least one central processing unit and having first and second processing units that can be distributed by software download to client computers that are connected via a network,
wherein the expert system is set up, based on a modeled transfer function for input data, to generate associated output data and output them to connected client computers, wherein the expert system is set up to record direct and/or indirect interactions of a user of a client computer as input data,
wherein the expert system has at least one server computer with the central processing unit, wherein the server computer is set up to connect via the network to a client computer after a software download of the distributable first and second processing units onto the client computer, the latter occurring by means of a data-communicating connection,
wherein the distributable second processing units are configured to connect as peers to client computers that are connected to the server computer via the network with a data-communicating connection, and—based on first input data derived from the respective user of the client computer and second input data transmitted by other client computers—to transmit a change in the output data derived by the first processing unit to the server computer, and to transmit second input data derived by the second processing unit to all of the other connected client computers,
wherein the server computer is set up to receive the derived change in the output data from all of the connected client computers and to use them as input data for the central processing unit in order to derive current values of the output data and to transmit them to all of the connected client computers again.

2. The expert system according to claim 1, wherein at least a part of the network is composed of the Internet.

3. The expert system according to claim 1, wherein the first processing units, the second processing units, and the central processing unit are implemented by means of artificial intelligence-based AI processing units.

4. The expert system according to claim 3, wherein the artificial intelligence-based AI processing units are composed of serially combined AI processing units with statistical artificial intelligence, symbolic artificial intelligence, fuzzy logic, fuzzy systems, or a neural network.

5. The expert system according to claim 1, wherein the server computer is a stand-alone computer or a computer farm.

6. The expert system according to claim 1, wherein a client computer is one of the following: a stand-alone computer, a smartphone, a personal digital assistant.

7. An expert system having at least one central processing unit and having first and second processing units that can be distributed by software download to client computers that are connected via a network,
wherein the expert system is set up, based on a modeled transfer function for input data, to generate associated output data and output them to connected client computers, wherein the expert system is set up to record direct and/or indirect interactions of a user of a client computer as input data,
wherein the expert system has at least one server computer with the central processing unit, wherein the server computer is set up to connect via the network to a client computer after a software download of the distributable first and second processing units onto the client computer, the latter occurring by means of a data-communicating connection,
wherein the distributable second processing units are configured to connect as peers to client computers that are connected to the server computer via the network with a data-communicating connection, and—based on first input data derived from the respective user of the client computer and second input data transmitted by other client computers—to transmit a change in the output data derived by the first processing unit to the server computer, and to transmit second input data derived by the second processing unit to all of the other connected client computers,
wherein the server computer is set up to receive the derived change in the output data from all of the connected client computers and to use them as input data for the central processing unit in order to derive current values of the output data and to transmit them to all of the connected client computers again,
wherein at least a part of the network is composed of the Internet,
wherein the first processing units, the second processing units, and the central processing unit are implemented by means of artificial intelligence-based AI processing units,
wherein the artificial intelligence-based AI processing units are composed of serially combined AI processing units with statistical artificial intelligence, symbolic artificial intelligence, fuzzy logic, fuzzy systems, or a neural network,
wherein the server computer is a stand-alone computer or a computer farm, and
wherein the client computer is selected from the group consisting of a stand-alone computer, a smartphone, and a personal digital assistant.
